(19) United States
(12) Patent Application Publication
(10) Pub. No.: US 2007/0023366 A1
(43) Pub. Date: Feb. 1, 2007

(54) Message holding device for removably suspending one or more articles therefrom

(76) Inventor: Gerald R. Bivens, Wheatridge, CO (US)

Correspondence Address: John L. Isaac;Suite 100, 7114 W. Jefferson Ave., Lakewood, CO, 80235-2309, US

(21) Appl. No.: 11/194,326

(22) Filed: Aug. 1, 2005

(51) Int. Cl. B42F 17/00

(52) U.S. Cl. 211/10

(57) ABSTRACT

A message holding device is disclosed and includes a first member having an inner surface, an outer surface and an exterior peripheral edge. A plurality of pockets are disposed in the first member inner surface. Each pocket is defined by an interior peripheral surface and a sloped bottom surface declining away from the first member exterior peripheral edge to form a seat at the bottom thereof. The pockets are aligned to define a plurality of angular orientations therebetween. A plurality of annular elements are provided, each being sized and shaped for disposition within and movement along one of the pockets. A second member is further provided and it has an inner surface, an outer surface and an exterior peripheral edge. The second member inner surface is secured to and spaced from the first member inner surface a distance such that each annular element is retained within its respective pocket and enables an article to be passed between the annular element and the second member inner surface such that it becomes wedged therebetween by gravity forces. Finally, a mechanism is provided for mounting the first member outer surface to a generally vertically-oriented surface to permit a plurality of articles to be mounted simultaneously at a plurality of angular orientations relative to the device.

### BACKGROUND OF THE INVENTION

1. Field of the Invention

The present invention relates generally to a holder device for attaching items thereto and, more particularly, to such a device that is designed to attach to a vertical surface and utilizes a roller ball for suspending items therefrom. Specifically, the present invention relates to such a holder device is designed to provide a message center capable of attaching notes or the like thereto.

2. Description of the Prior Art

There are many different types of devices for selectively holding paper and other items therefrom. Many such devices utilize spring clips or magnetic means to hold such items. These types of devices have the disadvantage of requiring the use of both of an operator's hands for inserting and removing the article to be suspended therefrom. To overcome this shortcoming, there have been many different types of holder devices designed which employ a ball which rides along and inclined surface opposite a wall-mounted surface. A retainer is then provided for the ball and a slot formed between the inclined surface and the wall-mounted surface were by an article can be inserted. Examples of such devices include U.S. Design Pat. No. 329,345, and U.S. Pat. No. 1,485,092, No. 2,377,488, No. 4,039,134, No. 4,085,848 and No. 6,149,117. In each of these devices, one or more roller balls are used to selectively capture items such as paper between the balls and a flat surface. These items are then held in place by gravity and are removable by moving the item substantially perpendicular to the alignment of the ball and groove containing the ball.

Unfortunately, a major drawback to such devices is that the channel carrying the ball must be aligned substantially vertical in order to permit gravity to act on the ball and wedge the item between the ball and a surface. Moreover, as a result of this arrangement, such items have been limited to the attachment of only one article from substantially one angular orientation. While it would be very desirable to be able to a patch a plurality of items or articles to such a holding device, prior art arrangements have not permitted this. Therefore, there remains a need in the art for such a device, and the present invention addresses and solves this particular problem in the art.

### SUMMARY OF THE INVENTION

Accordingly, it is one object of the present invention to provide a message holding device.

It is another object of the present invention to provide a holding device for selectively suspending a plurality of articles, such as pictures, memo notes and the like, therefrom.

Yet another object of the present invention is to provide a holder device having a plurality of attachment points along the perimeter thereof to permit selective attachment of a plurality of articles thereto oriented along a plurality of variable angles.

Still another object of the present invention is to provide a method of fund raising for an institution using a holder device capable of not only attaching a plurality of articles along the perimeter thereof but also capable of placing a message or picture relating to the institution on the device itself.

To achieve the foregoing and other objects and in accordance with the purpose of the present invention, as embodied and broadly described herein, a message holding device is disclosed. The device includes a first member having an inner surface, an outer surface and an exterior peripheral edge. A plurality of pockets are disposed in the first member inner surface. Each pocket is defined by an interior peripheral surface and a sloped bottom surface declining away from the first member exterior peripheral edge to form a seat at the bottom thereof. The pockets are aligned to define a plurality of angular orientations therebetween. A plurality of annular elements are provided, each being sized and shaped for disposition within and movement along one of the pockets. A second member is further provided and it has an inner surface, an outer surface and an exterior peripheral edge. The second member inner surface is secured to and spaced from the first member inner surface a distance such that each annular element is retained within its respective pocket and enables an article to be passed between the annular element and the second member inner surface such that it becomes wedged therebetween by gravity forces. Finally, a mechanism is provided for mounting the first member outer surface to a generally vertically-oriented surface to permit a plurality of articles to be mounted simultaneously at a plurality of angular orientations relative to the device.

In one modification of the invention, the pockets of the device are non-parallel to each other. In addition, the outer end of each of the plurality of pockets may be aligned along a different exterior peripheral edge of the device.

In another modification of the invention, each pocket of the device includes at least two separate channels having a common outer end proximate the peripheral edge of the device and which diverge away from each other terminating in separate interior end seats, the pocket having one annular member adapted to move within any of the channels thereof depending on the orientation of the device mounted on a vertical surface.

Yet another modification of the device includes at least three pockets with one pocket being oriented along the centerline of the device at a lowermost exterior peripheral edge thereof, and two other pockets being angled relative to each other and the opposite end corners of the peripheral edge from the first pocket, each of the pockets having seats disposed lower than the remainder of the pocket relative to the orientation of the device to enable articles to be removably attached thereto.

In another modification of the above, the second member outer surface is adapted to carry a message holder element. In one adaptation of this, the message holder element is in the form of a dry erase board. In another adaptation, the message holder element is in the form of a sleeve adapted to selectively carry a written or pictorial message member therein. In still another adaptation, the message holder element is rotatably mounted to the first member.

A further modification of the invention includes the first member outer surface having a mounting member for selective attachment to a substantially vertical surface to enable the device to selectively hold a plurality of articles suspended therefrom.

In still another modification of the invention, a holder device is provided for selectively suspending a plurality of articles oriented along a plurality of variable angles relative thereto. The device includes a base member having an inner surface, an outer surface and an exterior peripheral edge. A mechanism is provided for mounting the base member outer surface to a generally vertically-oriented surface. A plurality of pockets are disposed in the base member inner surface, each pocket having a sloped bottom surface with an elongated axis which declines away from the base member exterior peripheral edge to form a seat at the innermost portion thereof. The axis of the pockets are orientated at differing angles relative to each other. A plurality of balls are also provided, each being sized and shaped for placement within and movement along one of the pocket bottom surfaces. A cover member is also included and has an inner surface, an outer surface and an exterior peripheral edge. The cover member inner surface has a plurality of clip elements for attachment to the base member inner surface, the cover member being spaced from the base member such that each ball is retained within its respective pocket to enable an article to be passed between a ball and the cover member inner surface such that it becomes wedged therebetween by gravity forces. Finally, a message holder element is rotatably mounted on the cover member outer surface to provide selective angular orientations to permit a plurality of articles to be mounted simultaneously to the device at a plurality of angular orientations relative to the device.

Still another modification of the invention includes a product for use in a method of doing business to raise funds for an institution. The method includes the steps of creating a holding device for suspending articles therefrom, placing a message or picture relating to the institution on the device, and distributing the holding device in exchange for funds for supporting the institution's stated purpose to enable that institution to advertise as well as to provide a device as a useful message holder. The product is in the form of the holding device which includes first and second interconnected support plates having peripheral edges, the support plates being spaced from each other with each support plate having an inner surface facing the opposite support plate. A plurality of open pockets are disposed in the first plate inner surface and are open to the second plate inner surface. Each pocket includes a sloped bottom surface having a longitudinal axis declining away from an exterior peripheral edge the first plate to terminate in a recessed seat at the inward bottom thereof. Each pocket has its longitudinal axis aligned to define a different angular orientation from the remaining pockets relative to the peripheral edge. A ball is disposed within each pocket for movement along the bottom surface of the pocket, the balls being sized so that they are retained within their respective pockets between the plates wherein the spacing between plates enables an article to be passed between a ball and the second plate inner surface such that it is capable of being removably wedged therebetween by gravity forces. A mechanism is then provided for mounting the first plate to a generally vertically-oriented surface to permit a plurality of articles to be suspended simultaneously at a plurality of angular orientations relative to the device. Finally, an outer message holder element is rotatably mounted to the outer surface of the second plate to provide selective angular orientations thereof relative to the first and second plates, the outer message holder carrying a message or picture representing an institution for which funds are being raised and permitting the selective attachment of articles thereto at variable angular orientations.

### BRIEF DESCRIPTION OF THE DRAWINGS

The accompanying drawings which are incorporated in and form a part of the specification illustrate preferred embodiments of the present invention and, together with a description, serve to explain the principles of the invention. In the drawings:

FIG. 1 is a front perspective view of one embodiment constructed in accordance with the present invention;

FIG. 2 is a side view of the embodiment illustrated in FIG. 1;

FIG. 3 is a cross-sectional view taken substantially along line 3-3 of FIG. 1;

FIG. 4 is a front view of the base plate member of the embodiment illustrated in FIG. 1;

FIG. 5 is a top perspective view of a second preferred embodiment constructed in accordance with the present invention;

FIG. 6 is a bottom perspective view of the second preferred embodiment illustrated in FIG. 5;

FIG. 7 is a side view of the embodiment illustrated in FIG. 5 taken substantially along line 7-7 of FIG. 5;

FIG. 8 is a bottom side view of the embodiment illustrated in FIG. 5 taken substantially along line 8-8 of FIG. 5;

FIG. 9 is a perspective view of the inner surface of the base plate member of the second embodiment of FIG. 5;

FIG. 10 a perspective view of the outer surface of the base plate member of the second embodiment of FIG. 5;

FIG. 11 is a perspective view of the inner surface of the cover plate member of the second embodiment of FIG. 5;

FIG. 12 a perspective view of the outer surface of the cover plate member of the second embodiment of FIG. 5;

FIG. 13 is a perspective view of the inner surface of the message holder element of the second embodiment of FIG. 5;

FIG. 14 is a perspective view of the outer surface of the message holder element of the second embodiment of FIG. 5; and

FIG. 15 is a front view of a base plate member of an alternate embodiment similar to that illustrated in FIG. 1 and illustrating alternate pocket arrangements.

### DETAILED DESCRIPTION OF THE EXEMPLARY EMBODIMENTS

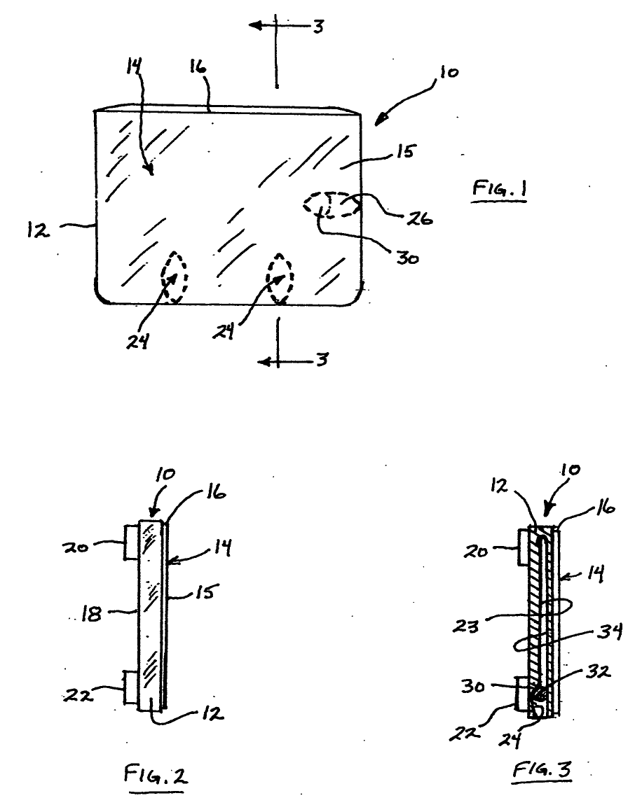

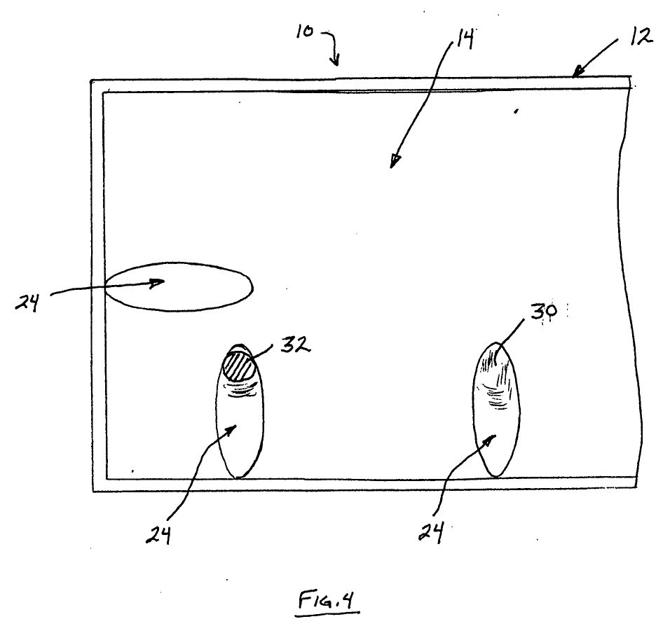

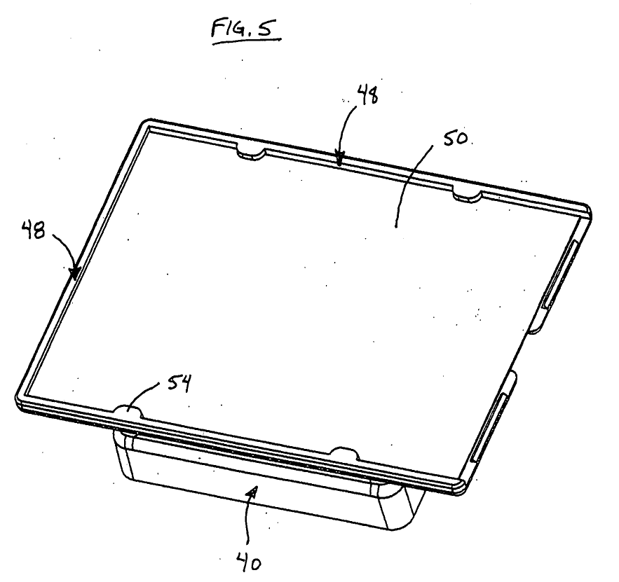

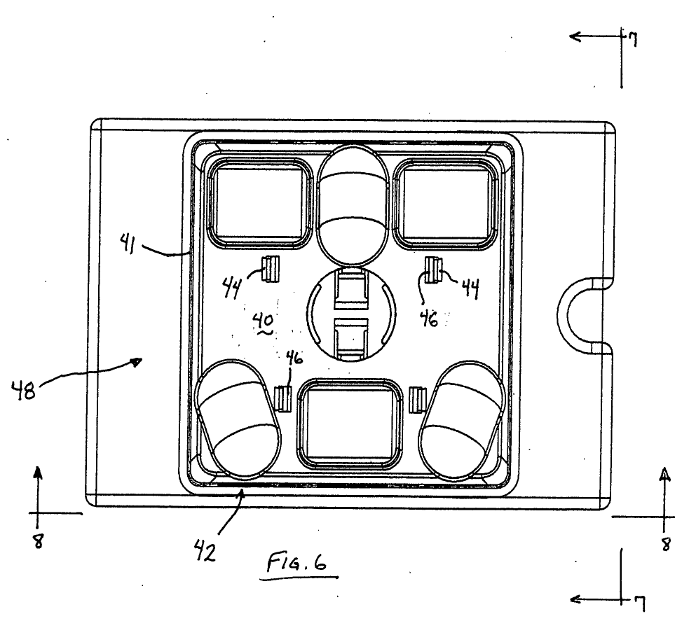

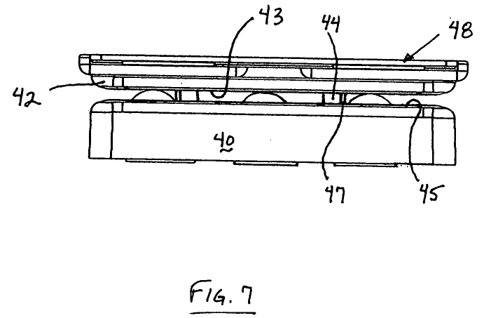

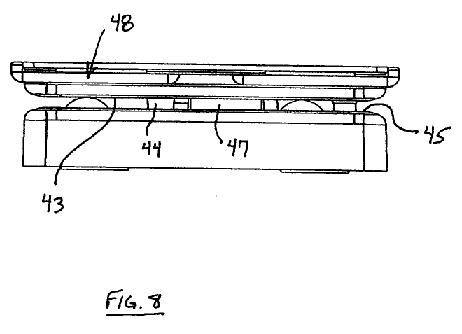

Referring first to FIGS. 1-4, the present invention is a message holding device 10 that includes a base member 12 and a cover member 14. The front surface of the cover member 14 may either be in the form of or include a sleeve 15 that can be opaque so that pictures and the like can be inserted through the opening 16 therein. Alternatively, the sleeve 15 can itself carry a message or be in the form of a picture as desired for advertising purposes and the like. The device 10 may be square, round or any other shape as desired. The rear portion or surface 18 of the base member 12 includes an attachment mechanism 20 of any desired type. This mechanism may be in the form of magnets 22, sticky tape elements or any other mounting mechanism known in the art such as hook and loop fasteners, and the like.

The inner surface 23 of the base member or element 12 of the device 10 includes a plurality of attachment members 24. In preferred form, there are three such attachment members 24, and each includes a pocket or recess 26 having a sloped bottom surface 28 terminating in a seat portion 30. An annular member preferably in the form of a movable ball 32 is disposed in the pocket 26 and is sized for seating in the seat 30. The inner surface 34 of the cover member 14 is spaced from the inner surface 23 of the base member 12 so that the balls 32 are retained therebetween for movement along the pockets 26. In this manner, the interaction between the ball 32 and the inner surface 34 can capture and removably hold in place any item a user desires, such as a paper, a picture, a towel and the like. This device 10 provides a plurality of sites for a user to attach a plurality of such items to the device 10, which in turn may be positioned on a vertical surface such as a refrigerator or the like.

A key feature of the present invention is that the axis of the plurality of pockets or recesses 26 are aligned along differing planes. In this manner, the device 10 enables an individual to position and attach articles to the device at a variety of positions around the device as well as at differing angles. When a paper is desired to be so removably attached, it is moved between the ball 32 and the inner surface 34. Once the article is in position, gravity pulls on the article and this in turn wedges the article between the ball 32 and the surface 34. When it is desired to remove the article from the device 10, it is simply moved substantially perpendicular to the axis of the pocket 26 in a manner to un-wedge the article. Typically, these types of arrangements are limited to a vertical direction relative to the position of the device on the vertical wall. However, with the present invention, there are a plurality of attachment points 20 from a plurality of different orientations to permit multiple articles to be attached about the periphery of the device 10.

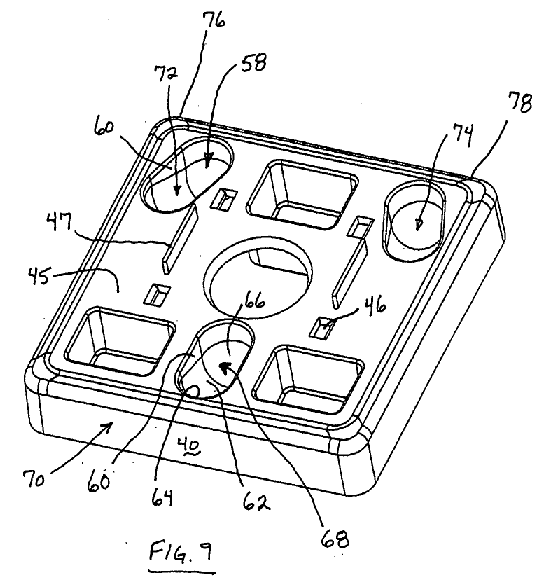

Referring now to FIGS. 5-8, a second preferred embodiment of a device 10 is illustrated. In this embodiment, a first or base member or plate 40 is provided for selective attachment at its outer surface 41 to a vertical wall surface as described below. A second or cover member or plate 42 is attached to the base member 40 utilizing a plurality of tongue and groove attachment members 44, 46. The inner surface 43 of the cover plate 42 is spaced from the inner surface 45 of the base member 40 by a plurality of raised ridge elements 47 extending outwardly from the surface 45 of the base member 40.

A message holder element 48 is preferably rotatively attached to the outer surface of the cover member 42 in a manner as described below. In preferred form, a dry erase board 50 is removably secured to the exterior surface 52 of the holder element 48 by a plurality of slide catches 54. It should be understood, however, that any desired item may be attached to the holder element 48 such as pictures, a sleeve for visual items, an advertisement communication or the like.

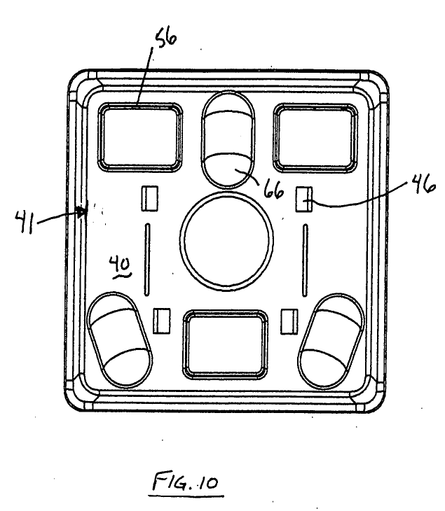

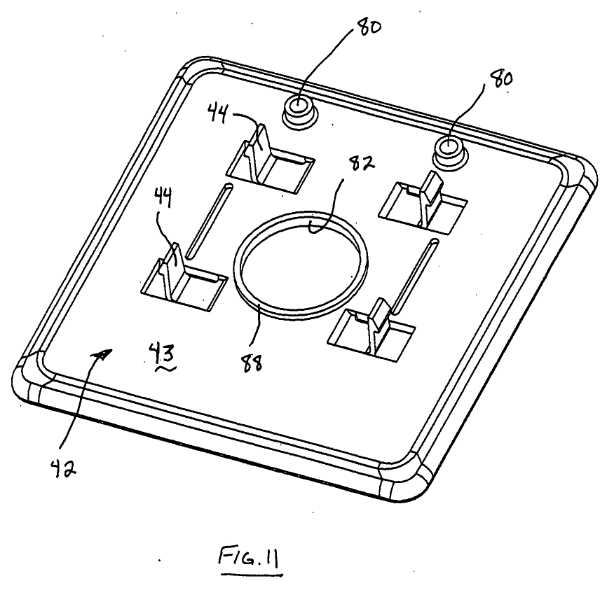

Referring now to FIGS. 9-10, the details of the base member or plate 40 are illustrated. As previously stated, the outer surface 41 of the base plate 40 preferably includes a plurality of individually spaced fins 56 which are adapted to be attached to sticky tape or the like, which in turn attach to a vertical wall surface. The apertures 46 are provided for receiving the connecting tongue elements 44 of the cover member 42. A plurality of pockets or recesses 58 are provided in the inner surface 45 and include an interior peripheral surface 60 along with a sloped bottom surface 62 which declines away from the exterior peripheral edge 64. A seat or socket 66 is disposed at the inner end of the pocket 58 and is sized to receive an annular element preferably in the form of a ball 32 as described in the prior embodiment. In this particular embodiment, there are three pockets 58. One pocket 68 is preferably aligned along the centerline of the lowermost peripheral edge 70. The remaining two pockets 72, 74 are aligned obliquely to the corners 76, 78, respectively. In this manner, there are a plurality of angular orientations for the pockets 58 in the base member 40.

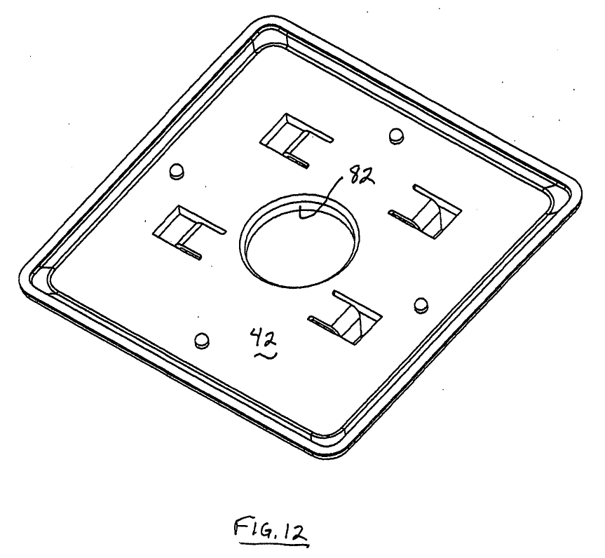

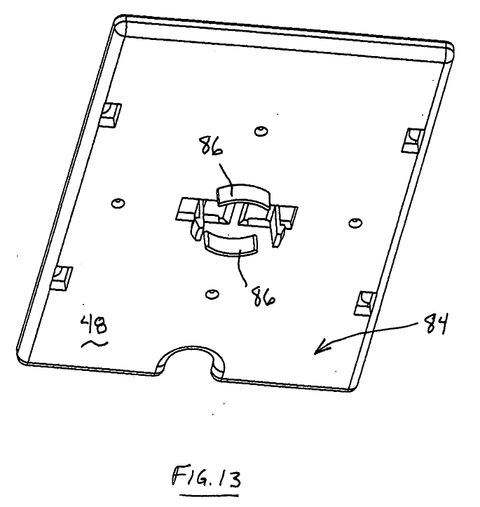

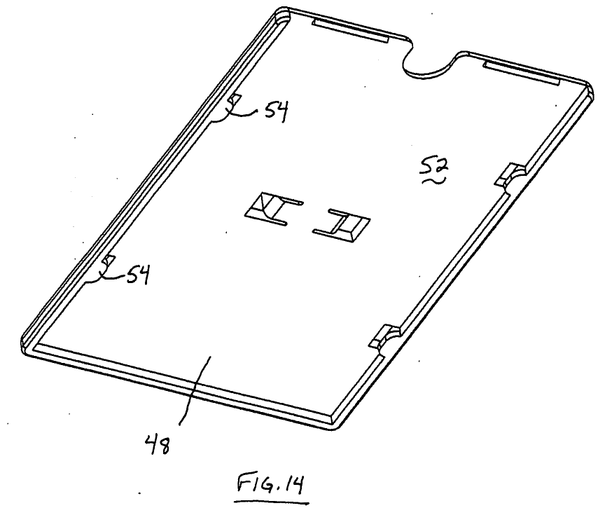

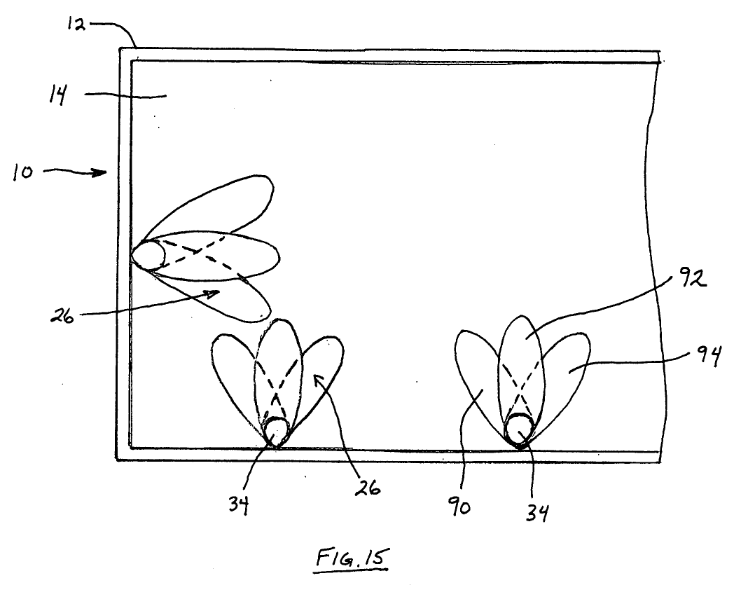

Referring to FIGS. 11-14, the cover plate 42 is illustrated in detail therein. The inner surface 43 is spaced from the inner surface 45 of the base plate 40 using the stop elements 80 and tongue members 44 for attachment to the grooves or notches 46 in the base plate 40. In this manner, the inner surface 43 of the cover plate 42 acts as an upper limiting element above the notches 58 of the base plate 40 so that the balls 32 disposed therein may not fall out inadvertently once the cover plate 42 is attached to the base plate 40. A central aperture 82 is provided to permit rotatable attachment and coupling thereto by the message holder element 48. In preferred form, the interior surface 84 of the message holder element 48 includes a pair of flanged catch elements 86 that extend outwardly therefrom. The catches 86 are spaced from each other so that they may snugly pass through the aperture 82 of the cover plate 42, the catch ends thereof snap locking to the ring 88 disposed about the aperture 82 on the inner surface 43 of the cover element 42. In this manner, the message holder element 48 may freely rotate about the remainder of the device 10.

As a result of the above construction, the variably aligned pockets 58 in the base member 40 along with their captured rotatable balls 34 permit a wide variety of articles to be attached to the device 10 by sliding them between the balls 32 and the inner surface 43 of the cover plate 42 from a variety of orientations and angles. Consequently, the device 10 is not limited to attachment of articles from one direction only as is the case of prior art devices. In addition, since the message holder element 48 is freely rotatable relative to the base plate 40 which in turn is secured to a vertical surface, attachment access to the various pockets 58 and balls 32 can be easily made along with various angular attachments to the outer surface 52 of the holder element 48 itself.

Referring now to FIG. 15, a modification to the prior embodiment is illustrated herein. The components of this illustrated embodiment are generally the same as those illustrated in the first embodiment except for the arrangements of the pockets 26 of the attachment members 24. In this particular embodiment, one or more of the attachment members 24 includes a pocket in the form of three recesses 90, 92 and 94 all interconnected at one end to carry the ball 34. The two outer recesses 90, 94 are angled relative to the essentially vertical recess 92 at an angle of about 30-45°. In this manner, when the device 10 is placed on a vertical surface, such as a refrigerator, the bottom attachment member(s) 26 operate to attach items using the vertical recess 92 with the ball 34 as in the prior embodiments. However, the side attachment member(s) 26 may still be used since there will be at least one recess, either 90 or 94, of each side member 26 that is oriented downwardly relative to the horizontal, thus allowing it to capture and hold items as well.

The device of the present invention may be used in a wide variety of different ways. It can be sold individually as a message holding device for use in a household in a variety of locations such as on a refrigerator, by the telephone and the like. It can also be used as a fundraiser for institutions such as schools, churches and the like. In this instance, the message holder element 48 may have a message or picture representing the particular institution that is running the fundraiser. Moreover, it can carry commercial indicia thereon for advertisement purposes to represent sponsors who are underwriting the fundraiser. It can also carry biblical messages or inspirational statements in place off or in conjunction with the dry erase board 50. Once the particular design for the message holder element 48 has been finalized, the device 10 can be sold for fund raising purposes similar to other devices previously used such as candy, cookies, and the like. The advantage of the present invention is that the device 10 will remain in a household along with any of the messages or information thereon, unlike many other devices used for fundraisers. Moreover, due to the multiple angular orientations of the attachment notch assemblies 58 along with the ability of the message holder element 48 to rotate relative to the rest of the device, the message holder device 10 of the present invention is capable of carrying multiple articles suspended therefrom on all sides thereof regardless of the orientation of the base member 40 on a vertical surface.

As can be seen from the above, present invention provides a unique message holding device. This holding device enables users thereof to attach messages and other articles to all sides of the device, not just the bottom portion thereof as is the case of prior art devices. Moreover, this device is simple to construct and is designed to prevent loss of the rotatable annular member, i.e. the ball, from within the notched recesses thereof. Finally, it provides numerous message capabilities as a result of the rotatable message holder portion which is mounted to the outer surface of the device in addition to any other message articles that may be attached to the device. The device is uniquely designed for not only commercial sale and use applications but is particularly adapt for use in fund raising instances.

The foregoing description and the illustrative embodiments of the present invention have been described in detail in varying modifications and alternate embodiments. It should be understood, however, that the foregoing description of the present invention is exemplary only, and that the scope of the present invention is to be limited to the claims as interpreted in view of the prior art. Moreover, the invention illustratively disclosed herein suitably may be practiced in the absence of any element which is not specifically disclosed herein.

I claim:

1. A message holding device comprising:
a first member having an inner surface, an outer surface and an exterior peripheral edge;
a plurality of pockets disposed in said first member inner surface, each said pocket being defined by an interior peripheral surface and a sloped bottom surface declining away from said first member exterior peripheral edge to form a seat at the bottom thereof, said pockets being aligned to define a plurality of angular orientations therebetween;
a plurality of annular elements, each being sized and shaped for disposition within and movement along one said pocket;
a second member having an inner surface, an outer surface and an exterior peripheral edge, said second member inner surface being secured to and spaced from said first member inner surface a distance such that each said annular element is retained within its respective pocket and enables an article to be passed between said annular element and said second member inner surface such that it becomes wedged therebetween by gravity forces; and
a mechanism for mounting said first member outer surface to a generally vertically-oriented surface to permit a plurality of articles to be mounted simultaneously at a plurality of angular orientations to said device.

2. The device as claimed in claim 1, wherein said pockets are non-parallel.

3. The device as claimed in claim 1, wherein the outer ends of said plurality of pockets are each aligned along a different exterior peripheral edge thereof.

4. The device as claimed in claim 3, wherein said each said pocket comprises at least two channels having a common outer end and diverging away from each other to separate interior end seats, said pocket having one said annular member adapted to move within any of said channels thereof depending on the orientation of said device.

5. The device as claimed in claim 3, wherein said device includes at least three said pockets, one said pocket being oriented along the centerline of said device at a lowermost exterior peripheral edge thereof, and two other said pockets being angled relative to each other and the opposite end corners of said peripheral edge from said first pocket, each of said pockets having seats disposed lower than the remainder of said pocket to enable articles to be removably attached thereto.

6. The device as claimed in claim 1, wherein said second member outer surface is adapted to carry a message holder element.

7. The device as claimed in claim 6, wherein said message holder element comprises a dry erase board.

8. The device as claimed in claim 6, wherein said message holder element comprises a sleeve adapted to selectively carry a written or pictorial message member therein.

9. The device as claimed in claim 6, wherein said message holder element is rotatably mounted to said first member.

10. The device as claimed in claim 1, wherein said first member outer surface includes a mounting member for selective attachment to a substantially vertical surface.

11. A holder device for selectively suspending a plurality of articles oriented along a plurality of variable angles relative thereto, said device comprising:
a base member having an inner surface, an outer surface and an exterior peripheral edge;
a mechanism for mounting said base member outer surface to a generally vertically-oriented surface;
a plurality of pockets disposed in said base member inner surface, each said pocket having a sloped bottom surface with an elongated axis and declining away from said base member exterior peripheral edge to form a seat at the innermost portion thereof, the axis of said pockets being orientated at differing angles relative to each other;
a plurality of balls, each being sized and shaped for placement within and movement along one said pocket bottom surface;
a cover member having an inner surface, an outer surface and an exterior peripheral edge, said cover member inner surface having a plurality of clip elements for attachment to said base member inner surface, said cover member being spaced from said base member such that each said ball is retained within its respective pocket to enable an article to be passed between said ball and said cover member inner surface such that it becomes wedged therebetween by gravity forces; and
a message holder element rotatably mounted on said cover member outer surface to provide selective angular orientations to permit a plurality of articles to be mounted simultaneously to said device at a plurality of angular orientations relative to said device.

12. The holder device as claimed in claim 11, wherein said device includes three said pockets, the axis of one said pocket being oriented along the centerline of said device at a lowermost exterior peripheral edge thereof, and the axis of the other two said pockets being angled relative to each other at the opposite end corners of said peripheral edge relative to said first pocket, each of said pockets having seats disposed lower than the remainder of said pocket to enable articles to be removably attached thereto.

13. The holder device as claimed in claim 12, wherein the axis of each of said other two said pockets is at an angle of approximately 30°-60° relative to the axis of said first pocket oriented along the centerline of said device at a lowermost exterior peripheral edge.

14. The holder device as claimed in claim 15, wherein said message holder element rotatably mounted on said cover member outer surface is adapted to carry a plurality of different elements selected from the group consisting of a dry ease board, a picture, and a clear sleeve adapted to carry an additionally selected item.

15. The holder device as claimed in claim 12, wherein the outer ends of said pockets are each aligned along a different exterior peripheral edge of said base member to provide a plurality of angular orientations for the suspension of articles from said device.

16. The holder device as claimed in claim 11, wherein said device further includes a pencil holder element and a key holder member depending therefrom.

17. In a method of doing business to raise funds for an institution wherein the method includes the steps of creating a holding device for suspending articles therefrom, placing a message or picture relating to the institution on the device, and distributing the holding device in exchange for funds for supporting the institution's stated purpose to enable that institution to advertise as well as to provide a device as a useful message holder, the holding device comprising:
first and second interconnected support plates having peripheral edges and spaced from each other, each said support plate having an inner surface facing the opposite support plate;
a plurality of open pockets disposed in said first plate inner surface and being open to said second plate inner surface, each said pocket including a sloped bottom surface having a longitudinal axis declining away from an exterior peripheral edge said first plate to terminate in a recessed seat at the inward bottom thereof;
each said pocket having its longitudinal axis aligned to define a different angular orientation relative to said peripheral edge from the remaining pockets;
a ball disposed within each said pocket for movement along the bottom surface of said pocket, said balls being sized so that said balls are retained within their respective pockets between said plates wherein the spacing between said plates enables an article to be passed between said ball and said second plate inner surface such that it is capable of being removably wedged therebetween by gravity forces;
a mechanism for mounting said first plate to a generally vertically-oriented surface to permit a plurality of articles to be suspended simultaneously at a plurality of angular orientations relative to said device; and
an outer message holder element rotatably mounted to the outer surface of said second plate to provide selective angular orientations thereof relative to said first and second plates, said outer message holder carrying a message or picture representing an institution for which funds are being raised and permitting the selective attachment of articles thereto at variable angular orientations.

18. In the business method as claimed in claim 17, the holding device wherein the outer message holder element of said holding device may selectively carry a commercial advertisement of interest to assist in subsidizing the costs of producing said device for distribution to increase the funds raised for the institution.

19. In the method as claimed in claim 18, the holding device wherein said device further includes a pencil holder element and a key holder member depending therefrom.

20. In the method as claimed in claim 18, the holding device wherein said outer message holder element is adapted to carry a plurality of different elements selected from the group consisting of a dry ease board, a picture, and a clear sleeve for holding user selected items.
